(19) United States
(12) Patent Application Publication
(10) Pub. No.: US 2026/0000074 A1
(43) Pub. Date: Jan. 1, 2026

(54) DUAL INSECT REPELLENT POLYMER GELS

(71) Applicant: The Government of the United States of America, as represented by the Secretary of the Navy, Arlington, VA (US)

(72) Inventors: Javier Jimenez, Washington, DC (US); James E. Cilek, Jacksonville, FL (US); Jeffrey G. Lundin, Burke, VA (US)

(73) Assignee: The Government of the United States of America, as represented by the Secretary of the Navy, Arlington, VA (US)

(21) Appl. No.: 19/319,872

(22) Filed: Sep. 5, 2025

Related U.S. Application Data
(63) Continuation-in-part of application No. 18/778,667, filed on Jul. 19, 2024.
(60) Provisional application No. 63/514,379, filed on Jul. 19, 2023.

(51) Int. Cl. A01N 37/18; A01N 25/34; A01N 31/06; A01N 33/00; A01N 37/08; A01P 17/00

(52) U.S. Cl. CPC A01N 37/18; A01N 25/34; A01N 31/06; A01N 33/00; A01N 37/08; A01P 17/00

(57) ABSTRACT

A composition comprising a first insect repellent compound, a second insect repellent compound, and a polymer that is miscible in the first insect repellent compound at 23° C. The polymer is dissolved in the first insect repellent compound. An example first insect repellent compound is N,N-diethyl-meta-toluamide, and example second insect repellent compounds are nootkatone, permethrin, or transfluthrin.

### REFERENCE TO RELATED APPLICATIONS

This application is a continuation-in-part application of U.S. application Ser. No. 18/778,667, filed on Jul. 19, 2024, which claims the benefit of U.S. Provisional Application No. 63/514,379, filed on Jul. 19, 2023. The prior applications and all other publications and patent documents referred to throughout this nonprovisional application are incorporated herein by reference.

### TECHNICAL FIELD

The present disclosure is generally related to insect repellent materials.

### DESCRIPTION OF THE RELATED ART

The World Health Organization estimates vector-borne diseases to kill 700,000 people annually, with mosquito-transmitted malaria being responsible for over 70% of those lives lost.¹ Preventative strategies for indoor protection such as long-lasting insecticidal bednets and indoor residual spraying have been effective in reducing Plasmodium falciparum infection in endemic Africa by half and the incident of clinical disease by 40% between 2000 and 2015.² However, outdoor protection is still dominated by aerosol-type sprays or topical lotions which are limited by their short efficacy time due to evaporation.³ As a result, efforts to increase insect repellent/insecticide efficacy times have included physically entrapping the substrate into a polymeric material for outdoor protection.⁴

Passively-controlled substrate release has most commonly been investigated for in vivo drug delivery systems through gelled polymer morphologies.^{5,6} The high degree of free space in gelled microstructures compared to paracrystalline materials allows for efficient substrate loading, thus making gels the preferred loading vessel for in vivo drug delivery systems.⁷ Physical gels give the added benefit of thermos-reversal properties through the formation and deformation of microcrystals at polymer chain entanglement junctions. At temperatures above this gel point, processes such as injection molding or fiber spinning can form consumer products such as bracelets or textiles without requiring a crosslinking/curing stage. Moreover, once depleted of their substrate the residual polymer can then be recycled due to maintaining a linear structure thus forming a circular economy.

Physical gels are a miscible polymer and solvent system that exhibit a storage modulus greater than its loss modulus (G″/G′=tan (δ)≤1) at a frequency of 1 Hz.⁸ The gel point where tan (δ)=1 is dependent on variables such as polymer concentration, polymer molecular weight, polymer/solvent types, and temperature. The insect repellent loading in a physical gel is maximized if the repellent acts as the gelling solvent. Therefore, the polymer and insect repellent must be miscible with one another. Hansen Solubility Parameters (HSPs) quantify chemical affinities through a tri-coordinate characterization that has been proven to determine polymer/solvent miscibility.⁹

Previous attempts towards insect repellent-infused polymeric materials have included melting or dissolution of polymer systems loaded with insect repellent and subsequent processing to form a finished product with insect repellent properties. These materials have reported adequate repellency in the order of weeks. However, much of these polymer/insect repellent systems are immiscible with one another. As a result, phase separation between the insect repellent and the polymer system may occur. This potential for phase separation limits the maximum insect repellent loading due to concerns with decreased mechanical properties, uneven distribution of insect repellent, and increased spinning breakages. Such concerns are also present in other polymer processing techniques such as injection molding. Moreover, techniques that require polymer melting demand high temperatures that result in vaporization and subsequent loss of insect repellent through processing. This vaporization results in lower insect repellent concentrations within the finished product and can also lead to safety concerns as polymer melt processing is typically performed above the flash point of various insect repellents (e.g., N,N-diethyl-meta-toluamide has a flash point of 155° C.).

Current outdoor protection from biting arthropods is typically achieved through insecticide-treated fabrics and topically applied repellents. Insecticide-treated fabrics (e.g., permethrin coatings) exhibit efficacy times over the order of months, and durability to withstand multiple wash cycles, however, depend on direct insecticide-vector contact to instigate knockdown, which poses risk of vector attack on untreated sites such as exposed skin.¹⁰⁻¹⁴ Consequentially, topically applied repellents are the dominant method for personal protection from biting arthropods on areas where permethrin-treated fabrics cannot safeguard. However, current repellents are typically limited to efficacy durations of ≤10 hours due to rapid evaporation and dermal absorption.^{3,15} Frequent reapplication for continuous protection can ultimately lead to noncompliance and potentially ensue health complications such as irritation, redness, rash, and swelling.^{16,17} As a result, alternative methods towards vector repulsion have included volatile pesticide embedment within polymeric matrices for extended, non-skin contact modes of protection.¹⁸⁻³² However, most attempts have demonstrated efficacy times in the magnitude of only multi-days, and none have transitioned to commercialization.

Recent breakthrough in solid-state, passively-controlled pesticide diffusing materials have found significant promise in designing semi-solid, physical gels solely composed of polymer and liquid pesticide.²² This thermoreversible gel demonstrates extensible, rubbery properties at room temperature with pesticide concentrations of 60 wt % and undergoes reversible sol-gel phase transition at elevated temperatures. Films cast from these gels demonstrate mosquito repellency for more than half a year—performing longer than any other known material to date—due to the exceptional substrate content in conjunction with desorption hinderance from the polymeric matrix. However, while these films demonstrate significant mosquito repellency throughout that duration, concerns were raised on the efficacy of the diffusing volatile pesticide (N,N-diethyl-meta-toluamide; DEET) which was apparent in form factors with lower surface areas. As such, this novel approach can be improved by increasing the repellency efficacy of the desorbing volatiles.

The potency of DEET has been recently improved through the addition of transfluthrin, a volatile pyrethroid pesticide, in repellent solutions during hand-in-cage assays.³³ Transfluthrin and other pyrethroids activate the voltage-gated sodium channels within the nerve membranes of mosquitoes which hyperactivates the nerve action potential.^{34,35} This sodium channel activation was determined to enhance odorant receptor-mediated repellency as performed by DEET.^{36,37} Therefore, transfluthrin and other pyrethroids, such as permethrin, should aid in the repellency efficacy of DEET-infused physical gels. Additionally, alternative insect neurotoxins may also enhance the chemosensory repulsion of DEET. Specifically, nootkatone is a natural compound found in grapefruit that demonstrates promise as both a repellent and insecticide.^{38,39} Recently, nootkatone demonstrated activation of odorant receptor-and ionotropic receptor-mediated neurons as well as inhibition of γ-aminobutyric acid-gated chloride channels which inhibits synaptic transmission.^{40,41} As such, these auxiliary pesticides in combination with DEET may demonstrate enhanced mosquito repellency over extended durations within the DEET-loaded physical gels due to the dual-modal mechanism of repulsion.

### SUMMARY OF THE INVENTION

Disclosed herein is a composition comprising a first insect repellent compound, a second insect repellent compound, and a polymer that is miscible in the first insect repellent compound at 23° C.

Also disclosed herein is a method comprising: providing a first insect repellent compound, providing a second insect repellent compound, providing a polymer that is miscible in the first insect repellent compound at 23° C., and combining the first insect repellent compound, the second insect repellent compound, and the polymer to form a composition. The polymer is dissolved in the first insect repellent compound.

### BRIEF DESCRIPTION OF DRAWINGS

A more complete appreciation will be readily obtained by reference to the following Description of the Example Embodiments and the accompanying drawings.

FIGS. 1A and 1B show DSC temperature sweeps of P(AN-VC) fibers without (FIG. 1A) and with (FIG. 1B) DEET.

FIG. 2 shows a linear correlation between gel temperature and concentration of P(AN-VC).

FIGS. 3A and 3B show the zero shear viscosity at varying temperature.

FIGS. 4A and 4B show micrographs of sub 100 μm filaments.

FIG. 5 shows an isothermal TGA at 30° C.

FIG. 6 shows mean percent repellency of female Aedes aegypti to poly(acrylonitrile-co-vinyl chloride) gel discs impregnated with DEET compared with screen only controls.

FIG. 7 shows relative weighted mean distance (cm) traveled of female Aedes aegypti from repellent source during exposure to single or multiple (3) gel discs impregnated with DEET in glass cylinders.

FIG. 8 shows DSC of P(AN-VC) fiber, P(AN-VC)/DEET gel, and P(AN-VC)/DEET gel fiber.

FIG. 9 shows XRD of P(AN-VC) fiber, P(AN-VC)/DEET gel, and P(AN-VC)/DEET gel fiber.

FIG. 10 shows TGA under 5° C./min ramp to 700° C. for P(AN-VC) fiber, DEET, and P(AN-VC)/DEET gel.

FIG. 11 shows TGA under isothermal at 130° C. for 10 h then 5° C. min⁻¹ ramp to 700° C. for P(AN-VC) fiber, DEET, and P(AN-VC)/DEET gel.

FIG. 12 shows isothermal TGA at 30° C. for 48 h for DEET and P(AN-VC)/DEET gel.

FIG. 13 shows three-phase exponential decay fitting for P(AN-VC)/DEET gel.

FIG. 14 shows mean repellency lifespan of large and small P(AN-VC)/DEET gel films.

FIG. 15 shows repellency of large P(ANVC)/DEET gel films throughout mosquito bioassay period at 0, 10, 21, and 30 weeks.

FIG. 16 shows weight loss of large and small P(AN-VC)/DEET gel films.

FIGS. 17A-C show ex situ DSC of DEET and auxiliary pesticides nootkatone (not, FIG. 17A), permethrin (perm, FIG. 17B), and transfluthrin (trans, FIG. 17C).

FIGS. 18A-C show IR spectroscopy of DEET-gels loaded with auxiliary pesticides.

FIGS. 19A-D show Aedes aegypti repellency and death upon exposure to auxiliary pesticide-loaded physical gels.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein are physical gels highly loaded with insect repellents for long-term insect repellent applications. The purpose is to repel biting arthropods (insects, ticks, etc.) for multiple weeks. The gel can exist in various forms such as fibers, film, patches, etc. as appropriate for the desired application. The system is composed solely of linear polymer and insect repellent that leads to high loading of insect repellent. The physical gel is formed through simple dissolution methods, resulting in facile fabrication.

The present composition comprises an insect repellent compound and a polymer that is miscible in the insect repellent compound at 23° C. Miscibility may persist or diminish at elevated temperatures such as 130° C., but it may be desirable to maintain miscibility at any temperatures at which the composition is made or used. The polymer may be dissolved in the insect repellent compound, and the composition may contain at least 1, 25, or 50 wt % of the insect repellent compound. Many insect repellent compounds are known in the art, including N,N-diethyl-meta-toluamide (DEET).

Physical gels demand miscible polymer and solvent systems to allow for polymer coil expansion and high degrees of polymer chain entanglements, which can develop into microcrystalline physical crosslinks upon thermal quenching below the sol-gel transition temperature (also known as gel temperature). Determining whether a polymer is miscible in the insect repellent compound may be done by physically combining the two. Candidate polymers may be selected based on the polymer's relative energy difference (RED) with respect to the insect repellent compound. A RED value of less than or equal to 1 can indicate miscibility, while greater than 1 can indicate immiscibility. The RED value may be calculated according to methods described below. One polymer suitable for use with DEET is poly (acrylonitrile-co-vinyl chloride) (P(AN-VC)). Other suitable polymers may include, but are not limited to, polystyrene, polyvinyl chloride, polyvinyl dichloride, polymethyl methacrylate, polysulfone, polyvinyl pyrrolidone, or a copolymer thereof.

The composition may be spun into fibers or formed into films. Fibers may be incorporated into a garment or other fabrics.

The composition demonstrates utilizing the insect repellent as the dissolving solvent for a polymeric material to form a highly insect repellent loaded physical gel for long-term passively controlled release. DEET was used in this study, as it is the most commercially used insect repellent, but these methods can apply to any insect repellent. The gelling polymer was chosen based on its miscibility with DEET as calculated by Hansen Solubility Parameters (HSP) using HSPiP software. Each chemical is characterized by their own parameters that are derived from their dispersion forces (δ_{D}), polar forces (δ_{P}), and hydrogen bonding forces (δ_{H}). These values may be calculated or found in Hansen Solubility Parameters A User's Handbook, Second Edition (CRC Press, 2007). This tri-coordinate parameter system can determine miscibility between a polymer and solvent system by calculating the distance between the select polymer and solvent system (Ra) through the following equation:

$${( Ra )}^{2} = 4 {( {δ}_{D 2} - {δ}_{D 1} )}^{2} + {( {δ}_{P 2} - {δ}_{P 1} )}^{2} + {( {δ}_{H 2} - {δ}_{H 1} )}^{2}$$

Miscibility between a solvent and polymer system is determined through the following equation:

$$RED = Ra / Ro$$

where Ro is the inherent interaction radius for a select polymer or copolymer. If Ra≤Ro (RED≤1), the solvent system will dissolve or swell the polymer. If Ra>Ro (RED>1), the solvent system will have no affinity to the polymer.

The HSPs and resulting RED values between DEET and various polymers is shown in Table 1. RED≤1 for an array of polymer underscoring its miscibility with DEET. Polyvinyl chloride is a thermoplastic polymer with a degradation temperature lower than its melting temperature, thus being an important polymer in fire retardant textiles. Specifically, modacrylic copolymers of acrylonitrile and vinyl chloride are commercially produced for various fire retardant applications such as children's garments, upholstery, faux fur, and protective outerwear. Modacrylic filaments composed of 1:1 mol/mol acrylonitrile-co-vinyl chloride (P(AN-VC)) had an RED value of 0.90 to DEET, suggesting miscibility.

TABLE 1
HSPs of DEET and various polymers

| | | | | | RED |
|---|---|---|---|---|---|
| Material | δd | δp | δh | Ro | DEET |
| DEET | 18.1 | 7.1 | 3.6 | xxx | xxx |
| P(AN-VC) 1:1 mol/mol | 20.9 | 11.9 | 4.4 | 8 | 0.93 |
| Polyurethane (PU) | 18.1 | 9.3 | 4.5 | 8 | 0.30 |
| Polyethylmethacrylate (PEMA) | 17.6 | 9.7 | 4.0 | 8 | 0.35 |
| Polystyrene (PS) | 18.5 | 4.5 | 2.9 | 8 | 0.35 |
| PET | 18.2 | 6.4 | 6.6 | 8 | 0.39 |
| Polycarbonate (PC) | 18.2 | 5.9 | 6.9 | 8 | 0.44 |
| Polylactic acid (PLA) | 18.5 | 8.0 | 7.0 | 8 | 0.45 |
| Polyvinylchloride (PVC) | 18.8 | 9.2 | 6.3 | 8 | 0.46 |
| Polymethylmethacrylate (PMMA) | 18.6 | 10.5 | 5.1 | 8 | 0.48 |
| Polyethylene oxide (PEO, PEG) | 17.0 | 10.0 | 5.0 | 8 | 0.49 |
| CyclicOlefinCopolymer (COC) | 18.0 | 3.0 | 2.0 | 8 | 0.55 |
| PDMS, Polysilicone | 17.2 | 3.0 | 3.0 | 8 | 0.56 |
| Polypropylene oxide (PPO, PPG) | 16.5 | 9.0 | 7.0 | 8 | 0.63 |
| Polyvinylacetate (PVA) | 17.6 | 2.2 | 4.0 | 8 | 0.63 |
| Polysulphone | 16.0 | 6.0 | 6.6 | 8 | 0.66 |
| Polycaprolactone | 17.7 | 5 | 8.4 | 8 | 0.66 |
| Polyethersulfone | 19.0 | 11.0 | 8.0 | 8 | 0.77 |
| Polyphenyleneoxide (PPO) | 17.9 | 3.1 | 8.5 | 8 | 0.79 |
| Epoxy | 17.4 | 10.5 | 9.0 | 8 | 0.82 |
| Polyoxymethylene (POM) | 17.2 | 9.2 | 9.8 | 8 | 0.85 |
| Polyethylene (PE) | 16.9 | 0.8 | 2.8 | 8 | 0.85 |
| Polypropylene (PP) | 18.0 | 0.0 | 1.0 | 8 | 0.95 |
| Polyvinylidenefluoride (PVDF) | 17.0 | 12.1 | 10.2 | 8 | 1.07 |
| Polyvinylbutyral | 18.6 | 4.4 | 13.0 | 8 | 1.23 |
| Polyethylcyanoacrylate | 18.7 | 13.8 | 11.5 | 8 | 1.30 |
| Nylon 66 | 17.4 | 9.9 | 14.6 | 8 | 1.43 |
| Polyacrylonitrile (PAN) | 22.4 | 14.1 | 9.1 | 8 | 1.55 |
| Polyvinylpyrrolidone (PVP) | 18.1 | 10.0 | 18.0 | 8 | 1.84 |
| Polyvinylalcohol (PVOH) | 15.0 | 17.2 | 17.8 | 8 | 2.31 |

This technique affords a significant improvement in the amount of insect repellent that can be loaded into the polymer, a reduction in the processing temperatures of the insect repellent-polymer composites, and a significant increase in the duration of release (and thus effective lifetime) of insect repellent. The insect repellent loading can achieve 68 wt % with the potential of increasing the mass percentage. The low temperature processing enables the incorporation of high vapor pressure and low flash point insect repellents into polymers to produce consumer products such as bracelets or textiles. Minimal loss of insect repellent through commercial manufacturing is anticipated for increased efficacy, decreased waste cost, and increased worker safety. Moreover, the chemical affinity of polymer and insect repellent is anticipated to prolong the repulsion efficacy due to extended diffusion times.

The gelling polymer type can extend to all those with RED≤1 as seen in Table 1. The polymer concentration can thus be adjusted to achieve similar gelation temperatures as those mentioned herein. Further applications can be linings for tents or other outdoor furniture, bednets, gelled components for fans (glade fans), and other applications with demand for insect repellency.

Also disclosed herein are transfluthrin, permethrin, and nootkatone within DEET-infused physical gels and the impact of these dual-modal composites on the repellency duration and efficacy against Aedes aegypti. It was determined whether DEET and the auxiliary pesticide are miscible within the polymeric composite, whether the desorbing volatiles retain identical pesticide-mixture compositions throughout extended desorption durations, and whether the addition of auxiliary pesticide within DEET-infused physical gels influence the effective repellency of Aedes aegypti throughout extended durations. This study revealed a highly-effective, multi-modal repelling semi-solid with extended performance durations instigated by the gelled morphology. This development has significant basic and practical implications on methodologies to enhance the effectiveness and longevity of passively-controlled substrate diffusing devices.

The dual-modal composition is made by combining a first insect repellent compound, a second insect repellent compound, a polymer that is miscible in the first insect repellent compound at 23° C. When combined, the polymer is dissolved in the first insect repellent compound.

An example composition uses DEET as the first insect repellent compound, nootkatone, permethrin, or transfluthrin as the second insect repellent compound, and poly (acrylonitrile-co-vinylchloride) as the polymer. The composition may comprise, for example, 50 to 75 wt. % of the first insect repellent compound, and at least 0.01 wt. % or 0.05 to 10 wt. % of the second insect repellent compound.

The composition may be made into a filament using methods known in the art. Such filaments may be incorporated into a garment. In another embodiment, the composition may be formed into a film.

The following examples are given to illustrate specific applications. These specific examples are not intended to limit the scope of the disclosure in this application.

Materials and Methods—Poly(acrylonitrile-co-vinyl chloride) (1:1 mol: mol) bulk fiber was donated by Kaneka Corporation. N,N-diethyl-meta-toluamide (DEET) was purchased from Sigma Aldrich. Hansen Solubility Parameter (HSP) analysis was performed on HSPiP software. Polymer dissolution occurred at internal temperatures not exceeding 130° C. under vigorous mechanical stirring until complete dissolution (around 3 hours). Gel spinning was conducted using a heated stainless steel syringe with capillary opening with a diameter of 2 mm. The filament line was cooled by flowing room temperature air at a quench length of 0.6 m.

Mechanical testing was performed on an Instron 343C-1 equipped with a 1 kN loadcell and pneumatic grips using samples with a gauge length of 10 mm and ramp rate of 100 mm min⁻¹. Films were cut into dog-bone shape with thickness of 2.5 mm and width of 5 mm.

Rheological analysis was conducted on a TA Instruments Discovery HR-2 rheometer with a cone and plate configuration (cone diameter=40 mm, angle=2°, and truncation=52 μm). Gelation temperature was determined through an oscillation temperature ramp (truncation gap length=50 μm, stress=5 Pa, frequency=1 Hz, and cooling rate of 2° C. min-1 from 90 to 0° C.). The samples underwent conditioning prior to testing at 90° C. for 1 min followed by preshear at 1 Hz for 1 min. Zero-shear viscosity was determined by iso-thermal oscillation frequency sweeps from 0.001 to 100 Hz at 1% strain. The samples underwent thermal conditioning prior to testing at the designated temperature for 2 min.

Differential Scanning calorimetry (DSC) was conducted on a TA Instruments Discovery DSC. Samples were first conditioned at −40° C. for 10 minutes and then underwent heating from −40 to 200° C. at 5° C./min under nitrogen. X-ray diffraction measurements were performed using a Rigaku SmartLab X-ray Diffractometer (XRD).

The SmartLab XRD was equipped with a Cu anode operating at 3 kW generating Cu Kα radiation. Measurements were taken with Bragg-Brentano Optics and a D/Tex Detector for 20 measurements from 10° to 75°. Thermogravimetric Analysis (TGA) was conducted on a TA Instruments Discovery TGA with platinum pans. The samples were under constant nitrogen purge at 40 mL min⁻¹. Heating ramps were conducted at 5° C. min⁻¹. Scanning Electron Microscopy (SEM) was conducted on a JEOL JSM-7600F. Operating voltage was set to 10 kV. Samples were sputter coated with at least 3 nm of gold prior to SEM analysis using a Cressington 108 auto sputter coater equipped with a MTM20 thickness controller.

Mosquito repellency of physical gels was evaluated using an adapted bioassay method that consisted of 3.8 cm diameter by 30.5 cm clear glass cylinders placed at a 45° incline. Small (1.2 cm diameter×2.5 mm width) and large (3.5 cm diameter×2.5 mm width) physically gelled discs were stored at-80° C. prior to testing and allowed to reach room temperature (approx. 22° C.) for at least 15 min but no more than 30 min at the start of the bioassay. The gelled disks were fixed between 2 wire screen discs, secured into an open-ended translucent polyethylene cap (4.5 cm diameter×1.0 cm width; SF-16, Caplugs, Buffalo, NY), and placed at the top of each tube. An average of 19±5 non-blood-fed, five to seven-day-old, insecticide-susceptible female Ae. aegypti (ORL1952strain) were mouth aspirated into each cylinder. Once mosquitoes were introduced into each tube, the end was capped with a screened disc of the same mesh size to prevent escape of mosquitoes and provide ventilation. Testing started at approximately 0700 with the location of mosquitoes in each tube recorded at 15 min, 30 min, 1 h, then hourly through 8 h of continuous exposure. To determine residual effectiveness of treatments, single discs were evaluated weekly through 12 wks. Between these time intervals, all discs were stored in un-sealed, clear plastic polyethylene bags (separated by large and mini discs) at ambient room temperature in a windowless laboratory under a 12:12 light-dark fluorescent overhead lighting cycle where approximately 1700 to 0500 was unlit. All disks were weighed prior to testing to determine the amount of repellent retained in each disk over time. Room temperature and relative humidity were recorded with a ThermoPro TP49 digital meter at the time of evaluation. Results are presented as the percent of mosquitos past the testing tube midline, termed as repellency.

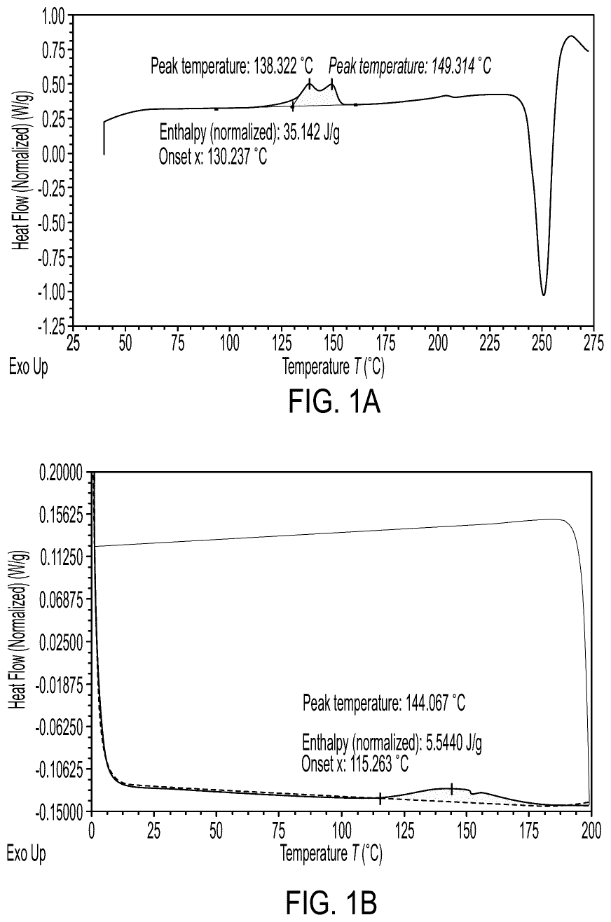

Determination of Polymer Dissolution through DSC Analysis—DSC temperature sweeps of P(AN-VC) fibers show two exothermic peaks at 138 and 146° C. that correlate to the recrystallization temperature of the vinyl chloride and acrylonitrile domains, respectively (FIG. 1A). Upon dissolution in DEET at temperatures not exceeding 130° C., the vinyl chloride peak disappeared leaving only the acrylonitrile recrystallization peak (FIG. 1B). Polyacrylonitrile has an RED value of 1.55 indicating its immiscibility with DEET, in accordance with the retention of its recrystallization peak.

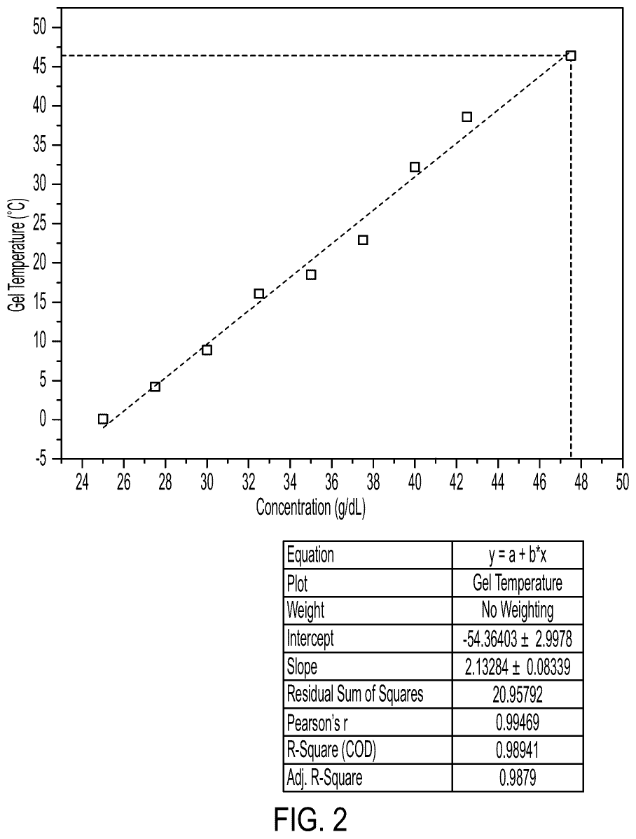

Tuning Physical Gels-A linear correlation between gel temperature and concentration of P(AN-VC) was observed (FIG. 2). For increased washfastness properties, a gel temperature of 45° C. was targeted to maintain a gelled morphology during a typical “warm” water setting during laundering. The extrapolated concentration for a 45° C. gel temperature was found to be ˜47.5 g/dL and was proven experimentally.

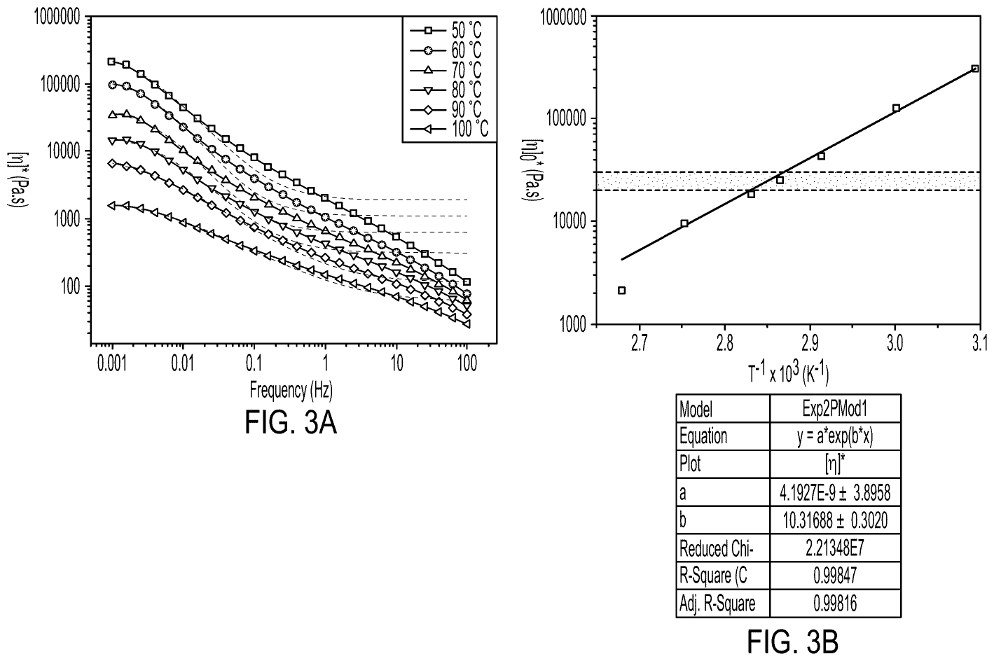

The resulting 47.5 g/dL P(AN-VC)/DEET physical gel exhibited physical properties to that of a hard gel at room temperature. However, the gel softened with increasing temperature, and flow properties were present in temperatures exceeding 45° C. To determine its processability, the zero shear viscosity at varying temperature were measured (FIGS. 3A and 3B). Specifically, dry-jet wet spinnability has been correlated to a polymer solution with a zero shear viscosity ranging from 20-30 kPa. A temperature of ˜76° C. was found to have a zero-shear viscosity within this range, thus underscoring for the potential of manufacturing processes such as injection molding and fiber spinning.

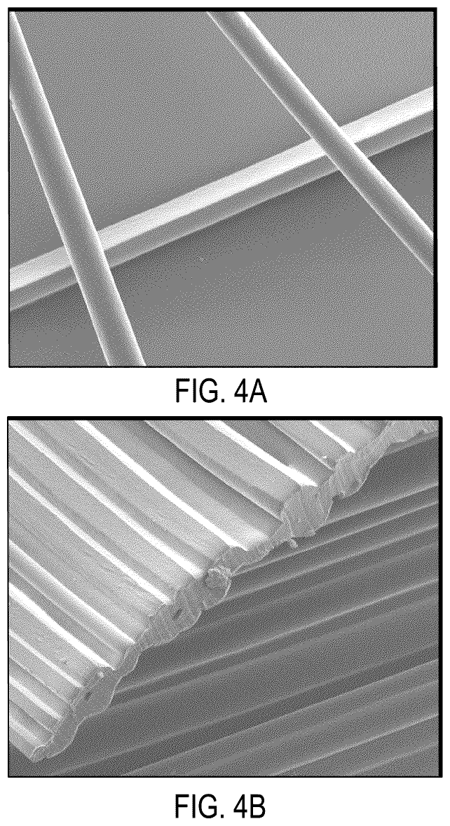

Gel Spinning of Insect Repellent-loaded Physical Gel Filaments—Spinnability was achieved with a syringe heating belt at a temperature of 160° C. The temperature of the exiting P(AN-VC)/DEET “semi-melt” was recorded at 70-80° C., underscoring loss of heat in the syringe system. Filaments were collected with a feed rate of 0.159 m/min and take up rate of 110 m/min resulting in a draw ratio of 691. Sub 100 um filaments were collected as seen in FIGS. 4A and 4B. Due to insufficient cooling of the filament line, the malleable filaments distorted on the surface of the take up roller as seen in FIG. 4A, and overlapping filaments fused together as seen in FIG. 4B.

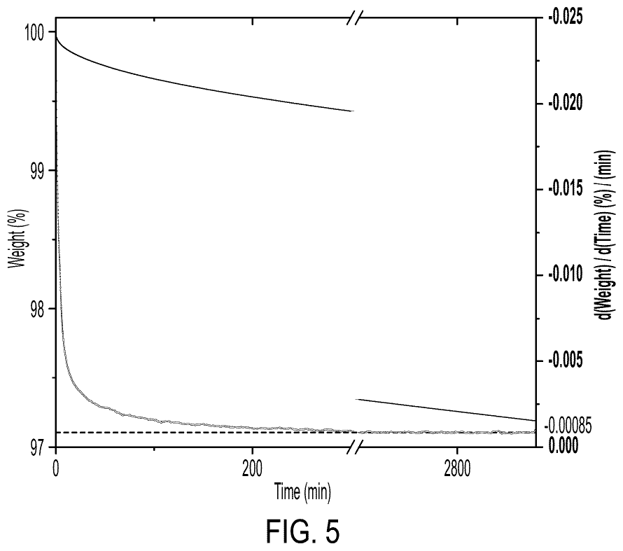

Diffusion Rate Characterization Through TGA—Isothermal TGA (FIG. 5) at 30° C. saw an initial first order decay until 250 min elapsed, where a zero-order decay was exhibited. The initial first order decay can be attributed to the vaporization of the DEET-DEET domains with minimal influence from the polymer. The combination of chemical affinity and physical entrapment associated in the DEET-polymer domains could have influenced the vaporization of DEET to follow a zero order decay. Beyond 250 min, a constant loss of 8.5×10⁻⁴%/min was observed, which correlates to a lifespan of 80 days.

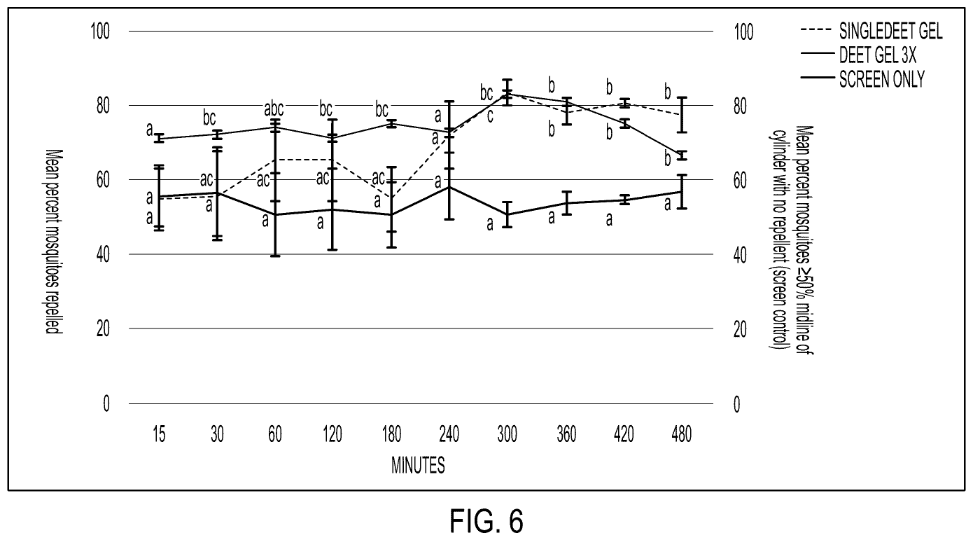

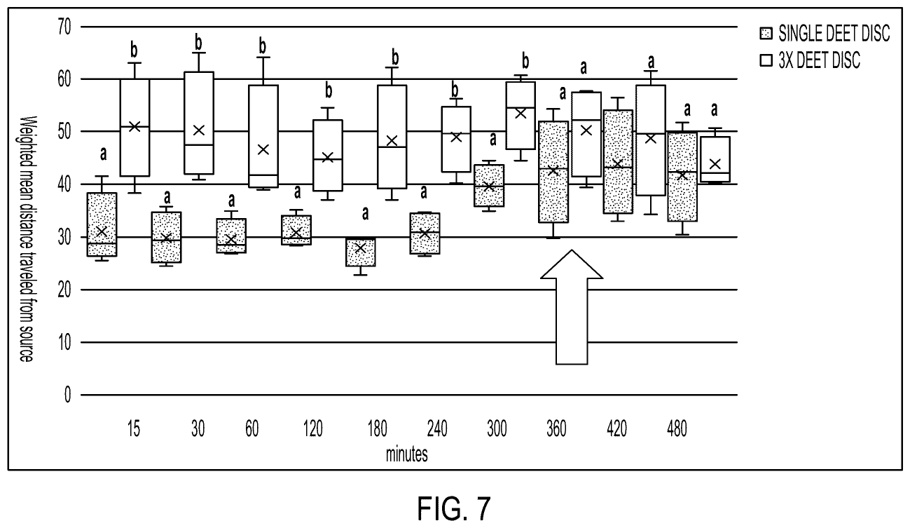

Live Insect Testing of P(AN-VC)/DEET Physical Gels—FIG. 6 shows repellency of 47.5 g/dL P(AN-VC)/DEET gels against live female Aedes aegypti mosquitos for 8 h. The DEET-gels exhibited immediate and sustained repellent release greater than that of control (screen only) over 8 h period. This result provides direct proof of principle of the repellency of the DEET-gels against live insects using a recently developed WHO-modified bioassay. FIG. 7 shows relative weighted mean distance (cm) traveled of female Aedes aegypti from repellent source during exposure to single or multiple (3) gel discs impregnated with DEET in glass cylinders.

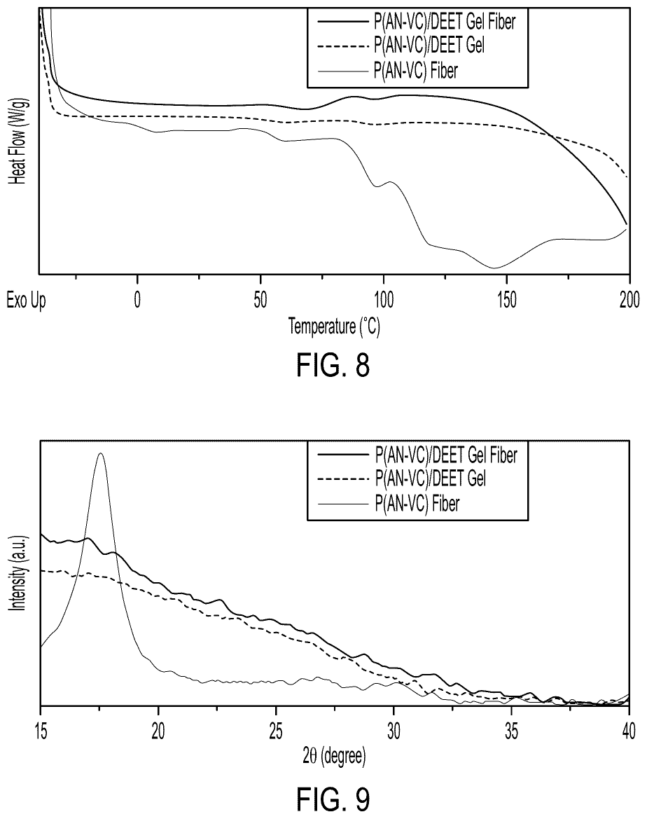

Physical gels can be identified by the dampened exothermic and endothermic peaks in DSC measurements, which are associated with crystallization and crystal melting, respectively. The DSC temperature sweep of P(AN-VC) fibers exhibit a glass transition temperature (Tg) at 55° C., associated with the VC domains (FIG. 8). The dramatic Tg at 100° C. is associated with the AN domains which allow for polymer relaxation and ensuing crystallization as indicated by the exothermic crystallization peak at 110° C. The endothermic peak at 145° C. correlates with the melting of partially gelled VC domains. The P(AN-VC)/DEET gels exhibited dampened VC and AN Tg shifts and complete loss of crystallization and melting peaks as expected from a predominately noncrystalline physical gel. The P(AN-VC)/DEET gel fibers exhibited slightly enhanced exothermic crystallization peaks possibly due to the high draw induced upon gel spinning.

Physical gels are expected to exhibit peak broadening in their XRD relative to their solid state due to its predominantly noncrystalline microstructure. The XRD diffractograms of P(AN-VC) fibers displayed a sharp peak at ˜17° which is associated with the (100) plane of PAN crystals (FIG. 9). The P(AN-VC)/DEET gel and gel fiber both exhibited dramatic peak broadening in what is assumed to be the PAN (100) peak, indicating smaller crystal sizes than in P(AN-VC) fibers. The peak also shifted towards a smaller incident angle, indicating larger d-spacing. This highly amorphous pattern supports the presence of a gelled morphology within these P(AN-VC)/DEET composites.

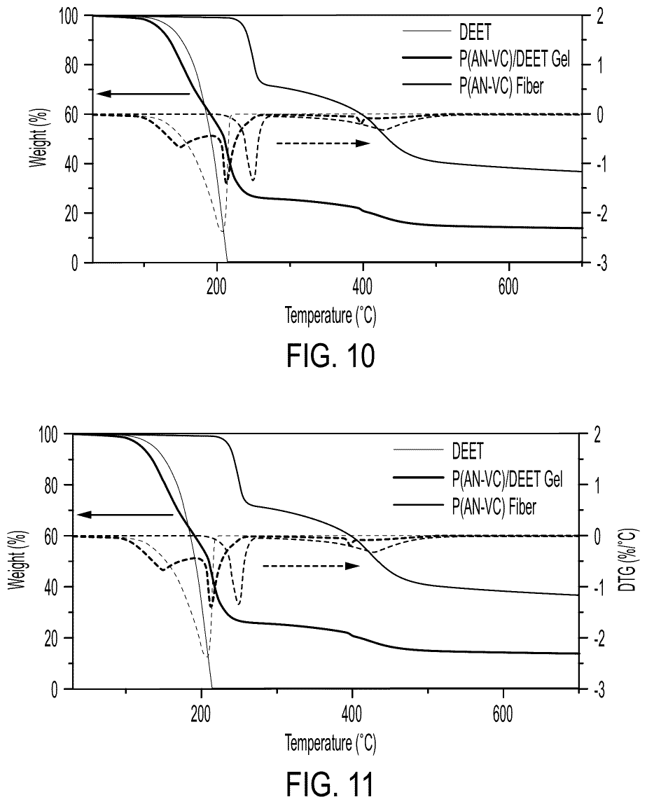

P(AN-VC)/DEET Desorption and Mosquito Bioassay—DEET desorption kinetics were measured through TGA and DTG to predict the lifespan of P(AN-VC)/DEET gels. Temperature ramps of P(AN-VC) fiber displayed a DTG peak at 250° C. with peak onset at ˜190° C., which was attributed to the dehydrochlorination of VC domains (FIG. 10). An additional small peak occurred at ˜400° C. associated with degradation of AN domains. Pure DEET exhibited onset loss at ˜100° C., which grew exponentially with increasing temperatures. Interestingly, a DTG peak in P(AN-VC)/DEET gels was seen at ˜140° C., which is associated with DEET loss, however, did not grow exponentially with temperature as with pure DEET, but reduced and plateaued until the VC dehydrochlorination peak at 210° C. This restriction of DEET loss could be due to the physical and chemical hindrance by the polymer matrix. The P(AN-VC)/DEET gels exhibited a downward shift in the VC dehydrochlorination DTG peak to 210° C., which could be due to the increased chain mobility, and decreased crystallinity in the VC-DEET solvated domains, thus lowering the activation energy required for dehydrochlorination.

DEET content in P(AN-VC)/DEET gels were determined through isothermal TGA at 130° C. over 10 hours to ensure complete DEET removal while preventing VC dehydrochlorination (FIG. 11). The 47.5 g dL⁻¹ P(AN-VC)/DEET gels were composed of 61.0±0.5 wt % DEET, suggesting ˜7 wt % DEET loss through gel processing. The gel displayed extended DEET retention at 130° C. compared to pure DEET, which is attributed to the physical and/or chemical hindrance by the polymer matrix.

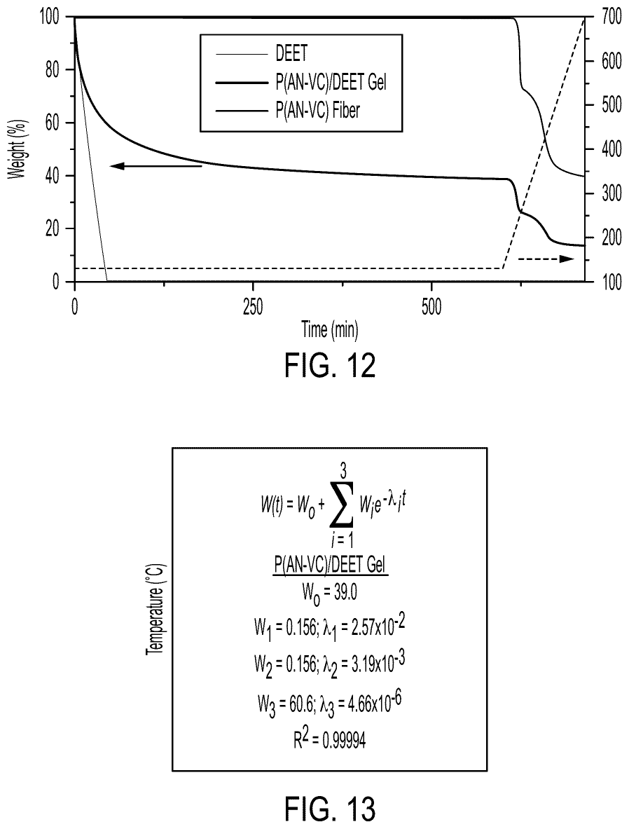

When held at 30° C. for 48 hours, the P(AN-VC)/DEET gels exhibited a loss of 1.2 wt % (2 wt % DEET) compared to a loss of 6.2 wt % in pure DEET (FIG. 12). The longevity of pure DEET contradicts studies indicating maximum reported efficacy times of 10 hours, underscoring the influence of surface area on desorption rates, especially when applied on skin via aerosol or spray, in conjunction with DEET loss through dermal absorption.

The 30° C. isothermal TGA were best fit with a three-phase exponential decay function (FIG. 13). Fixing the plateau weight (Wo) to the polymer composition within the gel resulted with rate constants (λ₁, λ₂, λ₃) of 2.69×10⁻², 3.16×10⁻³, and 4.66×10⁻⁶ min⁻¹, which correlate to mean lifespans of 37, 316, and 2.15×10⁵ min, respectively. This suggests that after 2.15×10⁵ min (21.3 weeks), 36.7% of the initial content of DEET will remain within the system. It is proposed that the gel exhibits a three-phase exponential decay desorption mechanism due to the multiple mechanisms for desorption that correlate with each phase. Cross-sectional SEM imaging of 0 and 20 h of isothermal TGA at 30° C. suggests the three-phase phenomena to be driven by surface skin development. The first phase is attributed to desorption of DEET-DEET domains on the surface of the gel, which leads to a rapid loss of DEET. The second phase undergoes a longer mean lifespan, but identical weight loss (Wᵢ) compared to the first phase, indicating suppressed DEET desorption. This phase could be DEET vaporization among DEET-P(AN-VC) domains in the immediate gel-air interface that results in skin formation on the surface of the gel membrane. The final phase is the resulting desorption of DEET in DEET-P(AN-VC) domains that diffuse through the concentration gradient induced by the newly formed skin.

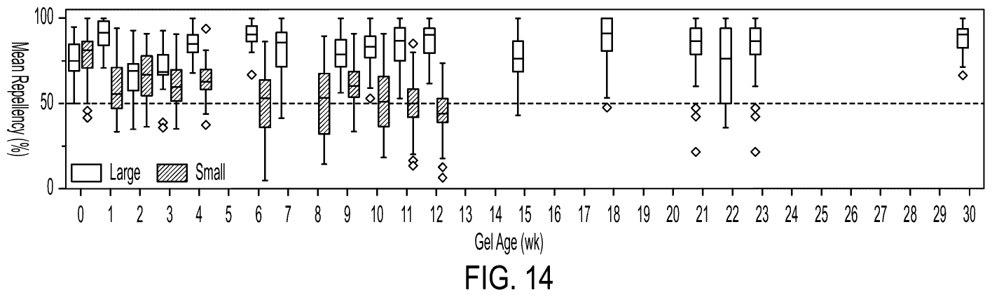

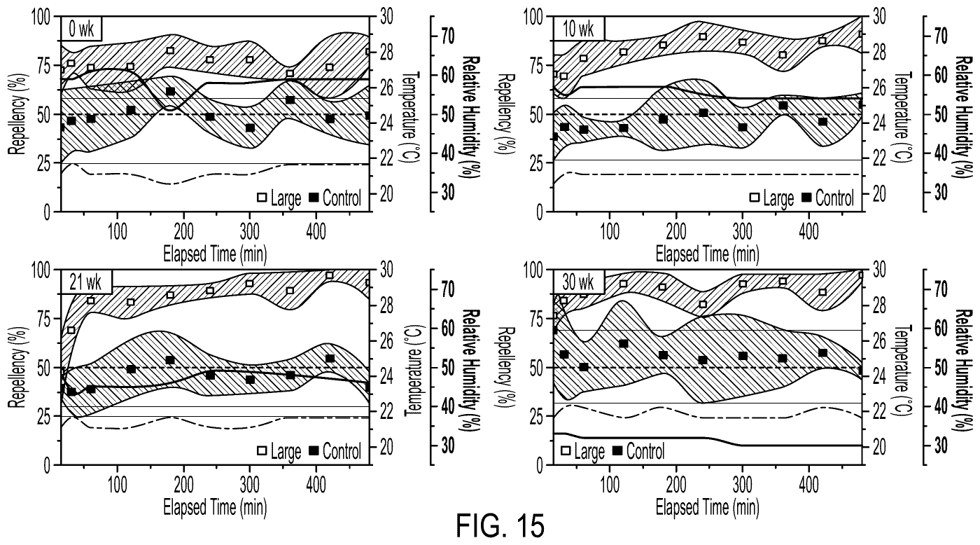

P(AN-VC)/DEET gel films were subjected to mosquito bioassay to evaluate their effective lifespan. Mosquito bioassay of circular P(AN-VC)/DEET films exhibited significant differences in mean repellent longevity dependent on the film diameter (FIG. 14). Large (3.5 cm diameter) P(AN-VC)/DEET films displayed significant mean repellency beyond 30 weeks, where a 50% repellency indicates normal, non-repellent, distributional behavior of mosquitoes around the testing midline. A minor deviation occurred at week 2, likely due to the behavioral variability in the cohort of mosquitos tested that week. Small (1.2 cm diameter) P(AN-VC)/DEET films failed to show significant repellency beyond week 3, with an undetermined variation in week 1 results. Up to 18 weeks testing duration, the degree of repellency was immediate and independent of time during each weekly 480 min (8 h) trial (FIG. 15). However, beyond week 18 a time-dependence developed resulting in a delay of approx. 30 min in each weekly trial to reach effective mosquito repulsion. The lower DEET concentration within the gel and increased skin thickness may decrease the concentration gradient and resulting rate of desorption, according to Fickian law.

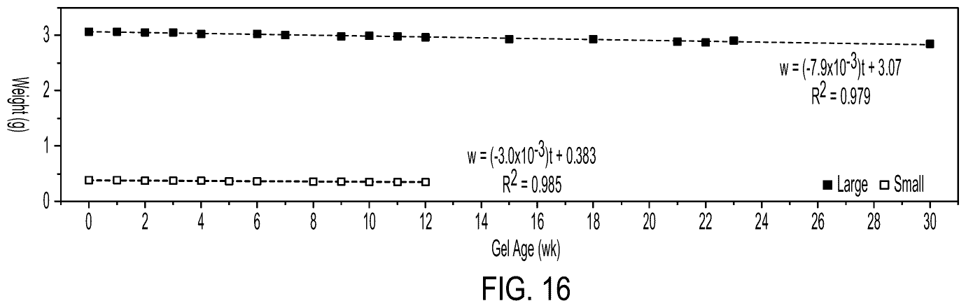

Large P(AN-VC)/DEET films exhibited consistent weight loss of 7.9 mg wk⁻¹, associated with DEET desorption, whereas the small films only lost 3.0 mg wk⁻¹ (FIG. 16). At 21 weeks, only 9.5 wt % of DEET was lost in large P(AN-VC)/DEET gels, inconsistent with isothermal TGA estimates of a 65.3 wt % loss. Discretions could be due to the consistent nitrogen flow of 40 mL min⁻¹ during isothermal TGA which can be faster than ambient indoor airflow during mosquito bioassay conditions, thus accelerating loss of DEET from an increased concentration gradient. Additionally, the mosquito bioassay was performed at lower temperatures (˜22° C.) than the 30° C. isothermal TGA, which also likely reduced DEET desorption. Interestingly, while the large P(AN-VC)/DEET gels lost 5.6 wt % DEET at 12 weeks, the small P(AN-VC)/DEET gels lost 16.4 wt % DEET. The samples have similar surface area-to-volume ratios (801 vs 803 m⁻¹, respectively) and exhibit different weight loss per unit surface area (0.42 vs 1.3 mg m⁼¹wk⁻¹, respectively). The larger weight loss per unit surface area in the small gel films than large gel films was attributed to the smaller concentration of DEET vapor within the fixed bioassay volume resulting in an increased concentration gradient between the gel and immediate volume surrounding the gel, which drives a faster rate of desorption per unit surface area over time.

Development of dual-modal mosquito repelling physical gels—The development of mosquito repelling physical gels are described elsewhere, where poly (acrylonitrile-co-vinyl chloride) (1:1 mol:mol) fiber (Kanecaron SB, Kaneka Americas Holding Inc., United States) was dissolved in N,N-diethyl-meta-toluamide (97%, DEET, Sigma Aldrich, United States) at a concentration of 47.5 g dL⁻¹ with internal temperatures of 130° C. under vigorous stirring until complete dissolution (2-3 hours).²² The auxiliary pesticide nootkatone (≥99%, NootkaShield, Evolva, United States), permethrin (90%, BOC Sciences, United States), or transfluthrin (95%, AK Scientific, United States) was loaded at onset of dissolution at 0.1, 1, or 5 wt % by weight of P(AN-VC)/DEET composite.

Morphological and diffusive characterization—Differential scanning calorimetry (DSC) was performed on a TA Instruments Discovery DSC. Samples underwent heating from −40 to 150° C. immediately followed by cooling from 150 to −40° C. at a ramp rate of 5° C. min⁻¹.

Live mosquito bioassay—Mosquito repellency of circular gel films (3.5 cm diameter×2.5 mm width) was evaluated using an adapted bioassay method that consisted of 3.8 cm diameter by 30.5 cm clear glass cylinders with wire mesh capped ends placed at a 45° incline.^{19,22,42,43} Specifically, one day prior to testing, three to five-day old, insecticide-susceptible Aedes aegypti (ORL1952 strain) mosquitoes were initially placed in plastic petri dishes and knocked down in a-20° C. freezer, (total time ≤2 min). The petri dishes were transferred to a chill table with a surface temperature of 15° C. for sexing and sorting. Twenty-five female mosquitoes were then transferred to each glass cylinder. Mosquitoes were fed 20 wt % sugar water during acclimation for 24 h. After acclimation, only tubes with no mosquito mortality were used in testing. The circular gel films were stored at −80° C. prior to testing and allowed to reach room temperature (approx. 22° C.) for at least 15 min but no more than 30 min at the start of the bioassay. The circular gel films were fixed between 2 wire screen discs, secured into an open-ended translucent polyethylene cap (4.5 cm diameter×1.0 cm width; SF-16, Caplugs, Buffalo, NY), and placed at the top of each tube. Testing started at approximately 0700 with the location of mosquitoes in each tube recorded at 15 min, 30 min, 1h, then hourly through 8 h of continuous exposure. To determine residual effectiveness of treatments, single knits were evaluated weekly through 12 weeks. Between these time intervals, all circular gel films were stored in un-sealed, clear plastic polyethylene bags (separated by large and mini discs) at ambient room temperature in a windowless laboratory under a 12:12 light-dark fluorescent overhead lighting cycle where approximately 1700 to 0500 was unlit. Results are presented as the percent of mosquitoes past the testing tube midline, termed as mean repellency, with a 0% midline indicating normal distribution throughout the tube. Mosquito death was recorded after 8 h of exposure followed by 16 h of acclimation.

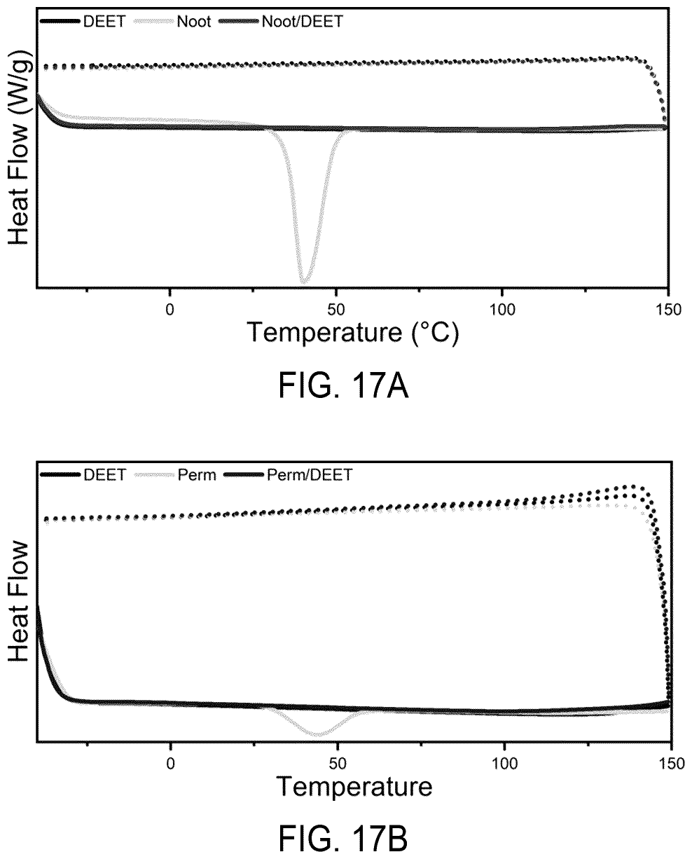

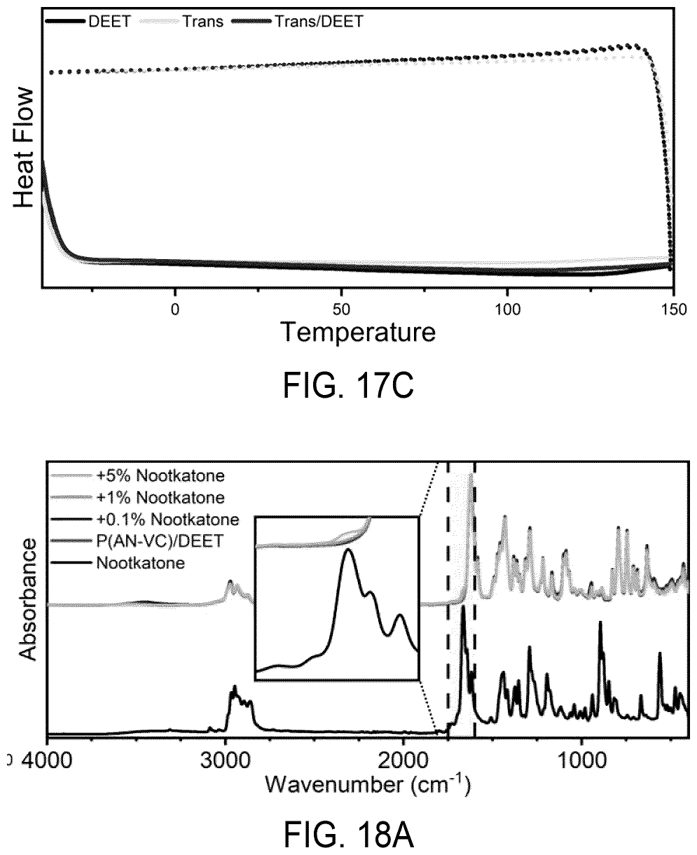

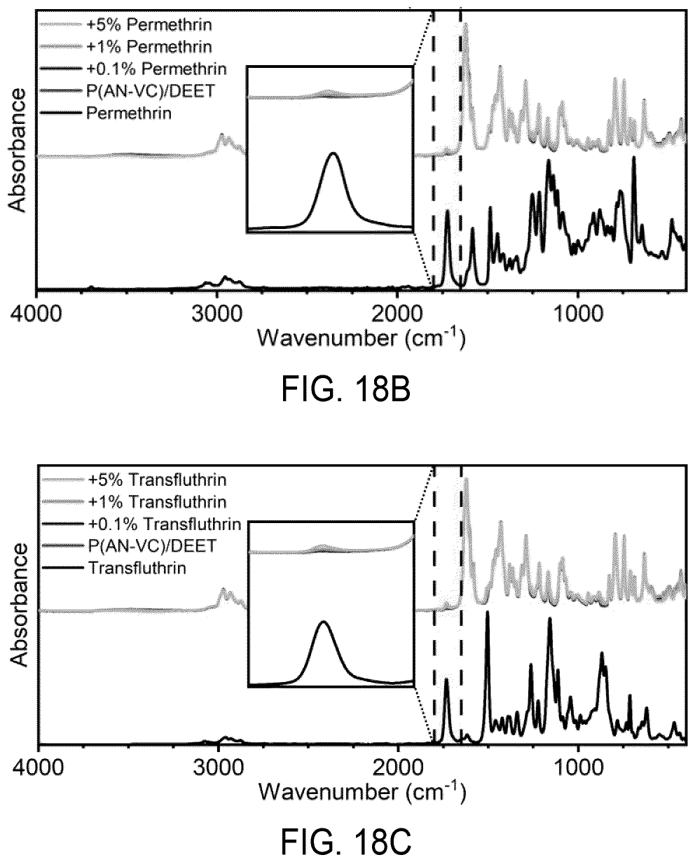

Results and Discussion—The desorbing volatiles of multicomponent substrates must be miscible in a liquid phase to ensure homogenous diffusate composition and release. Immiscible systems may result in phase separation within the composite resulting in differing desorption rates and longevities of effective release. Differential scanning calorimetry (DSC) was used to assess the miscibility between DEET and auxiliary pesticides through interrogating the phase change in mixing, considering that the auxiliary pesticides are solid at high purity (FIGS. 17A-C). Distinct endothermic melting peaks were present in nootkatone and permethrin at 41 and 44° C., respectively. Interestingly, transfluthrin only demonstrated a slight broad endothermic peak with an onset of around 90° C., contrary to reported melting temperatures of 32° C. Ex situ mixtures of DEET and auxiliary pesticide resulted in complete loss of all peaks associated with the auxiliary pesticides, indicating miscibility with DEET. The endothermic peaks associated with the auxiliary pesticides were also absent in situ the multicomponent gels, even though IR spectroscopy confirmed their presence (FIGS. 18A-C). The miscibility of DEET and auxiliary pesticide in situ suggests that the multicomponent volatiles are expected to maintain similar compositions throughout extended periods (i.e., beyond 30 weeks).

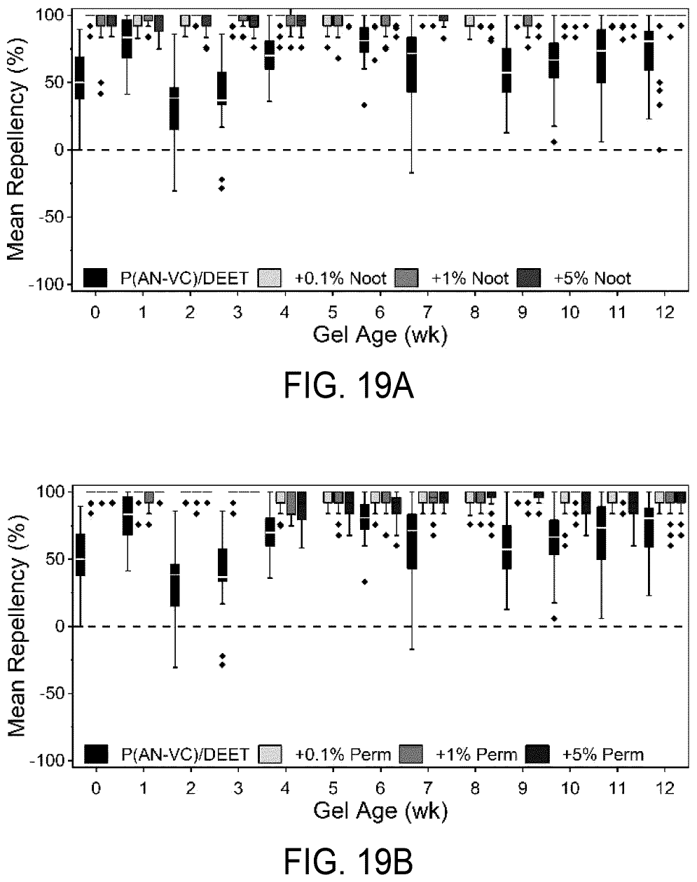

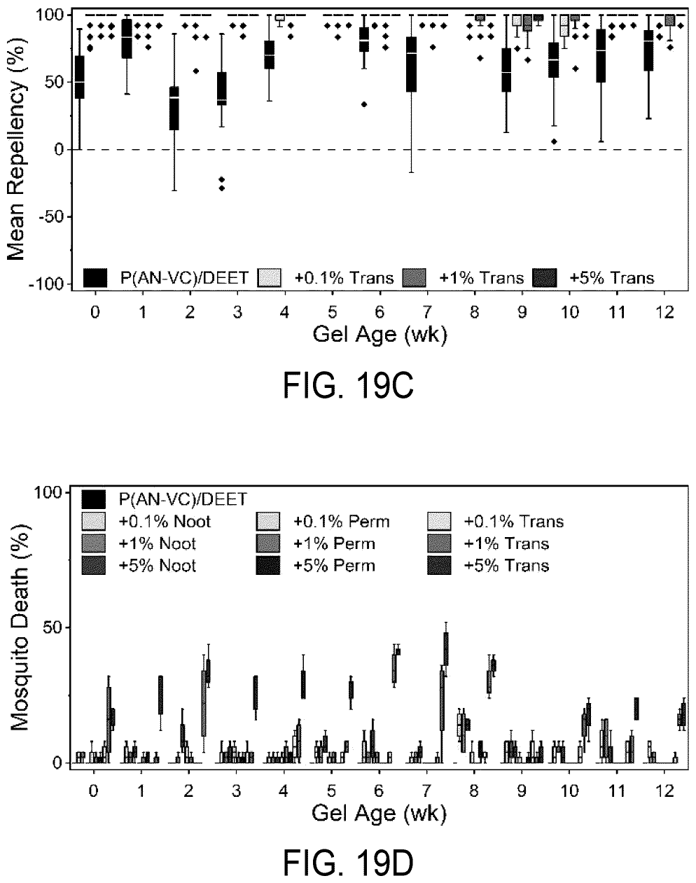

Mosquito bioassay of the physical gels demonstrated distinctly enhanced mosquito repulsion with the addition of auxiliary pesticides at all concentrations (FIGS. 19A-D). Specifically, the addition of nootkatone, permethrin, and transfluthrin resulted in enhanced average repulsions of >80% over the 12-week testing period, regardless of concentration. Moreover, the incorporation of transfluthrin (and nootkatone, slightly) demonstrated insecticide properties. Specifically, P(AN-VC)/DEET gels loaded with 5% transfluthrin achieved knockdown onset as early as 15 min and resulted in around 25% mosquito death after 8 h of exposure. Interestingly, while permethrin is a commonly used pesticide, especially for insecticide-treated textiles, permethrin-loaded gels showed no obvious indication of knockdown or mosquito death. Surprisingly, the nootkatone-loaded gels resulted in slightly higher mosquito death than permethrin-loaded gels.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the

### REFERENCES

(1) Global vector control response 2017-2030; World Health Organization.
(2) Bhatt, S.; Weiss, D. J.; Cameron, E.; Bisanzio, D.; Mappin, B.; Dalrymple, U.; Battle, K.; Moyes, C. L.; Henry, A.; Eckhoff, P. A.; et al. The effect of malaria control on Plasmodium falciparum in Africa between 2000 and 2015. Nature 2015, 526 (7572), 207-211.DOI: 10.1038/nature15535 From NLM Medline.
(3) Katz, T. M.; Miller, J. H.; Hebert, A. A. Insect repellents: historical perspectives and new developments. J Am Acad Dermatol 2008, 58 (5), 865-871. DOI: 10.1016/j.jaad.2007.10.005 From NLM Medline.
(4) Ryan, J. J.; Casalini, R.; Orlicki, J. A.; Lundin, J. G. Controlled release of the insect repellent picaridin from electrospun nylon-6,6 nanofibers. Polym Advan Technol 2020, 31 (12), 3039-3047. DOI: 10.1002/pat.5028.
(5) Jin, X.; Wei, C. X.; Wu, C. W.; Zhang, W. Customized Hydrogel for Sustained Release of Highly Water-Soluble Drugs. Acs Omega 2022, 7 (10), 8493-8497. DOI: 10.1021/acsomega.1c06106.
(6) Mullarney, M. P.; Seery, T. A. P.; Weiss, R. A. Drug diffusion in hydrophobically modified N,N-dimethylacrylamide hydrogels. Polymer 2006, 47 (11), 3845-3855. DOI: 10.1016/j.polymer.2006.03.096.
(7) Tong, X. M.; Lee, S.; Bararpour, L.; Yang, F. Long-Term Controlled Protein Release from Poly(Ethylene Glycol) Hydrogels by Modulating Mesh Size and Degradation. Macromol Biosci 2015, 15 (12), 1679-1686. DOI: 10.1002/mabi.201500245.
(8) Lin, K. Y.; Wang, D. M.; Lai, J. Y. Nonsolvent-induced gelation and its effect on membrane morphology. Macromolecules 2002, 35 (17), 6697-6706. DOI: 10.1021/ma020073y.
(9) Jimenez, J.; Ford, E. Mapping wet vs gel spinning in Hansen space. Polymer 2021, 124079. DOI: 10.1016/j.polymer.2021.124079.
(10) Orsborne, J.; DeRaedt Banks, S.; Hendy, A.; Gezan, S. A.; Kaur, H.; Wilder-Smith, A.; Lindsay, S. W.; Logan, J. G. Personal Protection of Permethrin-Treated Clothing against Aedes aegypti, the Vector of Dengue and Zika Virus, in the Laboratory. PLOS ONE 2016, 11 (5), e0152805. DOI: 10.1371/journal.pone.0152805.
(11) Pennetier, C.; Chabi, J.; Martin, T.; Chandre, F.; Rogier, C.; Hougard, J.-M.; Pages, F. New protective battle-dress impregnated against mosquito vector bites. Parasites & Vectors 2010, 3 (1), 81. DOI: 10.1186/1756-3305-3-81.
(12) Frances, S. P.; Watson, K.; Constable, B. G. Comparative toxicity of permethrin- and bifenthrin-treated cloth fabric for Anopheles farauti and Aedes aegypti. J Am Mosq Control Assoc 2003, 19 (3), 275-278.
(13) Sholdt, L. L.; Schreck, C. E.; Mwangelwa, M. I.; Nondo, J.; Siachinji, V. J. Evaluations of permethrin-impregnated clothing and three topical repellent formulations of deet against tsetse flies in Zambia. Medical and Veterinary Entomology 1989, 3 (2), 153-158. DOI: https://doi.org/10.1111/j.1365-2915.1989.tb00493.x.
(14) Vaughn, M. F.; Funkhouser, S. W.; Lin, F.-C.; Fine, J.; Juliano, J. J.; Apperson, C. S.; Meshnick, S. R. Long-lasting Permethrin Impregnated Uniforms: A Randomized-Controlled Trial for Tick Bite Prevention. American Journal of Preventive Medicine 2014, 46 (5), 473-480. DOI: https://doi.org/10.1016/j.amepre.2014.01.008.
(15) Lupi, E.; Hatz, C.; Schlagenhauf, P. The efficacy of repellents against Aedes, Anopheles, Culex and Ixodes spp.—A literature review. Travel Medicine and Infectious Disease 2013, 11 (6), 374-411. DOI: https://doi.org/10.1016/j.tmaid.2013.10.005.
(16) Schofield, S.; Crane, F.; Tepper, M. Good Interventions That Few Use: Uptake of Insect Bite Precautions in a Group of Canadian Forces Personnel Deployed to Kabul, Afghanistan. Military Medicine 2012, 177 (2), 209-215. DOI: 10.7205/milmed-d-11-00205.
(17) Chen-Hussey, V.; Behrens, R.; Logan, J. G. Assessment of methods used to determine the safety of the topical insect repellent N,N-diethyl-m-toluamide (DEET). Parasites & Vectors 2014, 7 (1), 173. DOI: 10.1186/1756-3305-7-173.
(18) Ryan, J. J.; Casalini, R.; Orlicki, J. A.; Lundin, J. G. Controlled release of the insect repellent picaridin from electrospun nylon-6,6 nanofibers. Polymers for Advanced Technologies 2020, 31 (12), 3039-3047. DOI: 10.1002/pat.5028.
(19) Fulton, A. C.; Thum, M. D.; Jimenez, J.; Camarella, G.; Cilek, J. E.; Lundin, J. G. Long-Term Insect Repellent Electrospun Microfibers from Recycled Poly(ethylene terephthalate). Acs Appl Mater Inter 2023, 15 (38), 44722-44730. DOI: 10.1021/acsami.3c08912.
(20) Tavares, M.; da Silva, M. R. M.; de Oliveira de Siqueira, L. B.; Rodrigues, R. A. S.; Bodjolle-d'Almeida, L.; dos Santos, E. P.; Ricci-Júnior, E. Trends in insect repellent formulations: A review. International Journal of Pharmaceutics 2018, 539 (1), 190-209. DOI: https://doi.org/10.1016/j.ijpharm.2018.01.046.
(21) Du, F.; Bonadies, I.; Longo, A.; Rupp, H.; Di Lorenzo, M. L.; Androsch, R. Sustainable Electrospun Poly(l-lactic acid) Fibers for Controlled Release of the Mosquito-Repellent Ethyl Butylacetylaminopropionate (IR3535). ACS Applied Polymer Materials 2023, 5 (7), 4838-4848. DOI: 10.1021/acsapm.3c00462.
(22) Jimenez, J.; Cilek, J. E.; Schluep, S. M.; Lundin, J. G. Designing thermoreversible gels for extended release of mosquito repellent. Journal of Materials Chemistry B 2024, 12 (37), 9249-9257. DOI: 10.1039/D4TB01384K.
(23) Sibanda, M.; Focke, W.; Braack, L.; Leuteritz, A.; Brünig, H.; Tran, N. H. A.; Wieczorek, F.; Trümper, W. Bicomponent fibres for controlled release of volatile mosquito repellents. Materials Science and Engineering: C 2018, 91, 754-761. DOI: https://doi.org/10.1016/j.msec.2018.06.016.
(24) Mapossa, A. B.; Focke, W. W.; Tewo, R. K.; Androsch, R.; Kruger, T. Mosquito-repellent controlled-release formulations for fighting infectious diseases. Malar J 2021, 20 (1), 165. DOI: 10.1186/s12936-021-03681-7.
(25) Muñoz, V.; Buffa, F.; Molinari, F.; Hermida, L. G.; García, J. J.; Abraham, G. A. Electrospun ethylcellulose-based nanofibrous mats with insect-repellent activity. Materials Letters 2019, 253, 289-292. DOI: https://doi.org/10.1016/j.matlet.2019.06.091.
(26) Misni, N.; Nor, Z. M.; Ahmad, R. Repellent effect of microencapsulated essential oil in lotion formulation against mosquito bites. Journal of Vector Borne Diseases 2017, 54 (1).
(27) Thum, M. D.; Weise, N. K.; Casalini, R.; Fulton, A. C.; Purdy, A. P.; Lundin, J. G. Incorporation of N,N,-diethyl-meta-toluamide within electrospun nylon-6/6 nanofibers. Journal of Applied Polymer Science 2022, 139 (48), e53237. DOI: https://doi.org/10.1002/app.53237.
(28) Bonadies, I.; Longo, A.; Androsch, R.; Jehnichen, D.; Gobel, M.; Di Lorenzo, M. L. Biodegradable electrospun PLLA fibers containing the mosquito-repellent DEET. European Polymer Journal 2019, 113, 377-384. DOI: 10.1016/j.eurpolymj.2019.02.001.
(29) Di Lorenzo, M. L.; Longo, A. N,N-Diethyl-3-methylbenzamide (DEET): A mosquito repellent as functional plasticizer for poly(l-lactic acid). Thermochim Acta 2019, 677, 180-185. DOI: https://doi.org/10.1016/j.tca.2019.02.004.
(30) Mapossa, A. B.; López-Beceiro, J.; Díaz-Díaz, A. M.; Artiaga, R.; Moyo, D. S.; Mphateng, T. N.; Focke, W. W. Properties of Mosquito Repellent-Plasticized Poly(lactic acid) Strands. Molecules 2021, 26 (19). DOI: 10.3390/molecules26195890 From NLM.
(31) Ferreira, I.; Brünig, H.; Focke, W.; Boldt, R.; Androsch, R.; Leuteritz, A. Melt-Spun Poly(D,L-lactic acid) Monofilaments Containing N,N-Diethyl-3-methylbenzamide as Mosquito Repellent. In Materials, 2021; Vol. 14.
(32) Jimenez, J.; Orlando, J. A.; Cilek, J. E.; Lundin, J. G. Poly-D,L-Lactic Acid as a Compatibilizer for Nootkatone-Embedded Nylon 12 Fabric Manufacturing. Fibers 2025, 13 (6), 74.
(33) Andreazza, F.; Valbon, W. R.; Wang, Q.; Liu, F.; Xu, P.; Bandason, E.; Chen, M.; Wu, S.; Smith, L. B.; Scott, J. G.; et al. Sodium channel activation underlies transfluthrin repellency in Aedes aegypti. PLOS Neglected Tropical Diseases 2021, 15 (7), e0009546. DOI: 10.1371/journal.pntd.0009546.
(34) Soderlund, D. M.; Bloomquist, J. R. Neurotoxic Actions of Pyrethroid Insecticides. Annual Review of Entomology 1989, 34 (Volume 34, 1989), 77-96. DOI: https://doi.org/10.1146/annurev.en.34.010189.000453.
(35) Soderlund, D. M.; Clark, J. M.; Sheets, L. P.; Mullin, L. S.; Piccirillo, V. J.; Sargent, D.; Stevens, J. T.; Weiner, M. L. Mechanisms of pyrethroid neurotoxicity: implications for cumulative risk assessment. Toxicology 2002, 171 (1), 3-59. DOI: https://doi.org/10.1016/S0300-483X(01)00569-8.
(36) Andreazza, F.; Valbon, W.; Dong, K. Transfluthrin enhances odorant receptor-mediated spatial repellency in Aedes aegypti. Pesticide Biochemistry and Physiology 2023, 192, 105387. DOI: https://doi.org/10.1016/j.pestbp.2023.105387.
(37) Liu, F.; Wang, Q.; Xu, P.; Andreazza, F.; Valbon, W. R.; Bandason, E.; Chen, M.; Yan, R.; Feng, B.; Smith, L. B.; et al. A dual-target molecular mechanism of pyrethrum repellency against mosquitoes. Nature Communications 2021, 12 (1), 2553. DOI: 10.1038/s41467-021-22847-0.
(38) Panella, N. A.; Dolan, M. C.; Karchesy, J. J.; Xiong, Y.; Peralta-cruz, J.; Khasawneh, M.; Montenieri, J. A.; Maupin, G. O. Use of Novel Compounds for Pest Control: Insecticidal and Acaricidal Activity of Essential Oil Components from Heartwood of Alaska Yellow Cedar. Journal of Medical Entomology 2005, 42 (3), 352-358. DOI: 10.1093/jmedent/42.3.352 (acccessed Mar. 25, 2025).
(39) Clarkson, T. C.; Janich, A. J.; Sanchez-Vargas, I.; Markle, E. D.; Gray, M.; Foster, J. R.; Black IV, W. C.; Foy, B. D.; Olson, K. E. Nootkatone Is an Effective Repellent against Aedes aegypti and Aedes albopictus. Insects 2021, 12 (5), 386.
(40) Fernandez Triana, M.; Andreazza, F.; Melo, N.; Ignell, R.; Afify, A.; Li, Y.; Zhang, D.-D.; Potter, C. J.; Dong, K.; Stensmyr, M. C. Grapefruit-derived nootkatone potentiates GABAergic signaling and acts as a dual-action mosquito repellent and insecticide. Current Biology 2025, 35 (1), 177-186.e176. DOI: https://doi.org/10.1016/j.cub.2024.10.067.
(41) Norris, E. J.; Chen, R.; Li, Z.; Geldenhuys, W.; Bloomquist, J. R.; Swale, D. R. Mode of action and toxicological effects of the sesquiterpenoid, nootkatone, in insects. Pesticide Biochemistry and Physiology 2022, 183, 105085. DOI: https://doi.org/10.1016/j.pestbp.2022.105085.
(42) Jiang, S.; Yang, L.; Bloomquist, J. R. High-throughput screening method for evaluating spatial repellency and vapour toxicity to mosquitoes. Medical and Veterinary Entomology 2019, 33 (3), 388-396. DOI: https://doi.org/10.1111/mve.12377.
(43) Owusu, H. F.; Müller, P. How important is the angle of tilt in the WHO cone bioassay? Malaria Journal 2016, 15 (1), 243. DOI: 10.1186/s12936-016-1303-9.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the

What is claimed is:

1. A composition comprising:
a first insect repellent compound;
a second insect repellent compound; and
a polymer that is miscible in the first insect repellent compound at 23° C.

2. The composition of claim 1, wherein the first insect repellent compound is N,N-diethyl-meta-toluamide.

3. The composition of claim 1, wherein the second insect repellent compound is nootkatone.

4. The composition of claim 1, wherein the second insect repellent compound is permethrin.

5. The composition of claim 1, wherein the second insect repellent compound is transfluthrin.

6. The composition of claim 1, wherein the polymer is poly (acrylonitrile-co-vinylchloride).

7. The composition of claim 1, wherein the composition comprises from 50 to 75 wt. % of the first insect repellent compound.

8. The composition of claim 1, wherein the composition comprises at least 0.01 wt. % of the second insect repellent compound.

9. The composition of claim 1, wherein the composition is in the form of a filament.

10. A garment comprising the filament of claim 9.

11. The composition of claim 1, wherein the composition is in the form of a film.

12. A method comprising:
providing a first insect repellent compound;
providing a second insect repellent compound;
providing a polymer that is miscible in the first insect repellent compound at 23° C.; and
combining the first insect repellent compound, the second insect repellent compound, and the polymer to form a composition;
wherein the polymer is dissolved in the first insect repellent compound.

13. The method of claim 12, further comprising:
forming a filament or a film of the composition.

14. The method of claim 12, wherein the first insect repellent compound is N,N-diethyl-meta-toluamide.

15. The method of claim 12, wherein the second insect repellent compound is nootkatone.

16. The method of claim 12, wherein the second insect repellent compound is permethrin.

17. The method of claim 12, wherein the second insect repellent compound is transfluthrin.

18. The method of claim 12, wherein the polymer is poly (acrylonitrile-co-vinylchloride).

19. The method of claim 12, wherein the composition comprises from 50 to 75 wt. % of the first insect repellent compound.

20. The method of claim 12, wherein the composition comprises at least 0.01 wt. % of the second insect repellent compound.
